(19) United States
(12) Patent Application Publication
(10) Pub. No.: US 2024/0051025 A1
(43) Pub. Date: Feb. 15, 2024

(54) ADDITIVELY MANUFACTURED POROUS COMPONENT STRUCTURE AND MEANS FOR MANUFACTURING SAME

(71) Applicant: Siemens Energy Global GmbH & Co. KG, Munich, Bayern (DE)

(72) Inventors: Johannes Albert, Berlin (DE); Jan Pascal Bogner, Berlin (DE); Ole Geisen, Berlin (DE); Michael Hajduk, Berlin (DE); Timo Heitmann, Berlin (DE); Christoph Kiener, München (DE)

(73) Assignee: Siemens Energy Global GmbH & Co. KG, Munich, Bayern (DE)

(21) Appl. No.: 18/266,595

(22) PCT Filed: Dec. 17, 2021
(86) PCT No.: PCT/EP2021/086455

§ 371 Date: Jun. 12, 2023

(30) Foreign Application Priority Data
Dec. 18, 2020 (EP) 20215593.3

(51) Int. Cl. B22F 10/38; B22F 10/28; B22F 10/366; B22F 5/00

(52) U.S. Cl. CPC B22F 10/38; B22F 10/28; B22F 10/366; B22F 5/009; B33Y 80/00

(57) ABSTRACT

A method for providing CAM manufacturing instructions for the powder-bed-based additive manufacturing of a component wherein a geometry of the component, with a solid material region, a transition region, and a porous component region, is defined on the basis of CAD data. Irradiation parameters for the manufacturing of the component, including an irradiation power, a scanning speed, a scanning pitch, and a layer thickness, are varied within the transition region in such a way as to form a porosity gradient of the structure of the component between the solid material region of the component and the porous component region.

### CROSS REFERENCE TO RELATED APPLICATIONS

This application is the US National Stage of International Application No. PCT/EP2021/086455 filed 17 Dec. 2021, and claims the benefit thereof. The International Application claims the benefit of European Application No. EP20215593 filed 18 Dec. 2020. All of the applications are incorporated by reference herein in their entirety.

### FIELD OF INVENTION

The present invention relates to a method for providing manufacturing instructions for the additive, powder bed-based manufacturing of a coolable component or component area, comprising a solid material area, a transition area, and a porous area. Furthermore, a corresponding additively manufactured component area and means for manufacturing same and a computer program product are specified.

The component is preferably provided for use in the hot gas path of a gas turbine, such as a stationary gas turbine. The component structure particularly preferably relates to a component of a combustion chamber or a resonator component such as a Helmholtz resonator or a part thereof. The component is preferably a component to be cooled, for example coolable via fluid cooling. For this purpose, the component preferably has a tailor-made porosity or permeability for a corresponding cooling fluid, for example cooling air.

Alternatively, the component can be another coolable or partially porous component, for example one applied for use in the automotive or in the aviation sector.

### BACKGROUND OF INVENTION

Modern gas turbine components or comparable components are the subject matter of continuous improvement in order to improve their efficiency. However, among other things, this results in higher and higher temperatures in the hot gas path. The metallic materials for rotor blades, in particular in the first stages, are continuously improved with respect to their strength at high temperatures, creep stress, and thermomechanical fatigue.

Generative or additive manufacturing is also increasingly becoming of interest for the series manufacturing of the above-mentioned turbine components, such as turbine blades or burner components, due to its disruptive potential for the industry.

Additive manufacturing methods (also referred to colloquially as “3D printing”) comprise, for example, as powder bed methods selective laser melting (SLM) or laser sintering (SLS), or electron-beam melting (EBM). Further additive methods are, for example, “directed energy deposition (DED)” methods, in particular laser build-up welding, electron-beam or plasma powder welding, wire welding, metallic powder injection molding, so-called “sheet lamination” methods, or thermal spraying methods (VPS LPPS, GDCS).

A method for additive construction of a component having a porous support structure is known, for example, from EP 3 278 908 B 1. The structure porosity which—in contrast to the present invention—relates here to the support structure, is accordingly not provided for cooling, however.

A density gradient of additively constructed material is furthermore described in general in WO 2020/018604 A1.

Furthermore, document WO 2014/2023521 describes a method for manufacturing a three-dimensional component by means of selective laser melting, wherein corresponding parameters can be adapted for finishing the microstructure and/or a porosity of the component.

Additive manufacturing methods have furthermore proven to be particularly advantageous for complex or filigree components, for example labyrinthine structures, cooling structures, and/or light construction structures. In particular, additive manufacturing is advantageous due to a particularly short chain of process steps, since a manufacturing or production step of a component can take place substantially on the basis of a corresponding CAD (computer aided design) file and the selection of corresponding manufacturing parameters.

A CAD file or a computer program product can be provided or comprised, for example, as a (volatile or nonvolatile) memory medium, such as a memory card, a USB stick, a CD-ROM, or DVD, or also in the form of a downloadable file from a server and/or in a network. The provision can furthermore take place, for example, in a wireless communication network by the transfer of a corresponding file having the computer program product.

A computer program product can contain program code, machine code or numeric control instructions, CAM (computer aided manufacturing) control instructions, G code, and/or other executable program instructions in general.

The computer program product can furthermore contain geometry data or construction data in a three-dimensional format or as CAD data or can comprise a program or program code for providing these data.

The manufacturing of gas turbine blades by means of the described powder bed-based methods (LPBF, “laser powder bed fusion”) advantageously enables the implementation of novel geometries, concepts, solutions, and/or design, which reduce the manufacturing costs and/or the setup and throughput time, optimize the manufacturing process, and can significantly improve, for example, a thermomechanical design or durability of the components.

Blade components manufactured in a conventional manner, for example by casting, are significantly inferior to the additive manufacturing route, for example, with respect to their design freedom and also in regard to the required throughput time and the high costs connected thereto as well as the manufacturing effort.

By means of the mentioned LPBF method, it is already possible to manufacture porous materials which can be used for various applications, for example, for cooling or for mechanical damping.

Such structures are also already sometimes integrated in solid material components. This necessarily results in structurally problematic transitions between porous areas and dense or impermeable solid material areas of the components. The mentioned transitions often represent a weak point upon stress of the entire component in operation, which has the result that the components are usable not at all or not for a long time or reliably for their intended use, since the mechanical attachment of the porous areas and thus the dimensional stability of the component as a whole cannot be ensured. Large tension gradients arise during the manufacturing and have the result in particular that the porous areas “tear off” in the transition upon stress.

### SUMMARY OF INVENTION

It is therefore an object of the present invention to specify means, using which the attachment of the mentioned porous structural areas can be reliably ensured components that are to be additively manufactured. The mentioned porous material areas can thus be used in a functionally reliable manner in the corresponding component at all for the first time, which decisively improves the structural integrity of additive cooling structures, for example.

This object is achieved by the subject matter of the independent claims. Advantageous embodiments are the subject matter of the dependent claims.

One aspect of the present invention relates to a method for providing CAM manufacturing instructions for the additive, powder bed-based manufacturing of a component, wherein a geometry of the component, comprising a solid material area, a transition area, and a porous component area, is defined on the basis of CAD data, wherein irradiation parameters for the manufacturing of the component, comprising, inter alia, an irradiation power, a scanning speed, a scanning or hatching distance, and a layer thickness, are varied within the transition area and during the manufacturing of the component (layer by layer) in such a way that a porosity gradient of the structure of the component is formed between the solid material area of the component and the porous component area.

A CAM strategy can already advantageously be provided by the present invention in preparation for the process, thus upstream of the actual manufacturing of the component, which then inevitably results in advantageous structural properties in the transition area upon its execution in the construction process. In other words, the transition area is designed as significantly more structurally robust by the mentioned means, so that it also withstands significantly greater force flows and stresses of the component in operation.

In one embodiment, at least one irradiation parameter from those mentioned is selected in such a way that the structure of the component in the porous component area is between 5% and 40%, preferably approximately 20%. The dimensioning of the porosity according to this embodiment is particularly expedient for fluid-cooled component structures, through which flow can accordingly take place.

In one embodiment, at least one irradiation parameter is selected in such a way that the structure of the component in the transition area has a gradually varying porosity between approximately 0 in the solid material area to a porosity value of the porous component area of preferably approximately 20%. A graduated or (gradually) varying porosity advantageously enables the structural reinforcement of the transition area particularly efficiently. In particular, this embodiment advantageously allows the suppression of cracks or crack centers during the construction and thus a mechanically particularly robust transition area to be manufactured.

In one embodiment, at least one irradiation parameter is selected in such a way that the porosity is formed continuously or infinitely (fluidly) gradually varying. This embodiment is distinguished by the same advantages relating to the mechanical strength as the last-mentioned embodiment.

In one embodiment, at least one irradiation parameter from those mentioned above is selected in such a way that the porosity is formed varying in a stepped manner (gradually). A sufficient structural or mechanical cohesion between the solid material area and the porous component area can still be manufactured by this embodiment, wherein the procedural implementation of the component manufacturing can, however, be simplified with respect to the process preparation.

In one embodiment, an irradiation power, in particular laser power, is reduced in the transition area from the solid material area to the porous component area, whether gradually stepped or continuously. This parameter particularly effectively influences the porosity properties of the constructed structure.

In one embodiment, a scanning speed in the transition area is increased from the solid material area to the porous component area, whether gradually stepped or continuously. This parameter also particularly effectively influences the porosity properties of the constructed structure.

In one embodiment, a scanning distance or hatching distance is increased in the transition area from the solid material area to the porous component area, whether gradually stepped or continuously. This parameter also particularly effectively influences the porosity properties of the constructed structure.

In one embodiment, two or more of the mentioned parameters are varied gradually stepped or continuously and simultaneously in the transition area to provide the corresponding advantageous porosity properties.

A further aspect of the present invention relates to a method for additively manufacturing the component by means of selective laser melting, selective laser sintering, and/or electron-beam melting using the CAM manufacturing instructions provided as described above, wherein the component is accordingly provided in the transition area (between the solid material area and the porous component area) with graduated porosity properties (porosity gradient).

A further aspect of the present invention relates to a computer program or computer program product, comprising commands which, upon the execution of a corresponding program by a computer, for example for controlling the irradiation or exposure in an additive manufacturing facility, cause these means to implement the manufacturing instructions as described above or to manufacture the component accordingly.

A further aspect of the present invention relates to an additively manufactured component structure, which comprises a solid material area, a transition area, and a porous component area, wherein the porous component area is a cooling body, which is configured to have a cooling fluid flow through it to cool the structure in operation, and where the transition area (also) includes a porous structure, through which grating-like solid material elements or support elements extend, which are preferably manufactured using corresponding process parameters for the solid material. This aspect of the invention advantageously allows the reinforcement of the structural cohesion between the solid material area and the porous area in an alternative manner. In particular, it allows the described solid material elements to provide an advantageously enlarged attachment surface between the solid material and the porous material. The structural attachment of the porous area can thus furthermore be improved.

In one embodiment, the solid material elements permeate the porous structure at least partially in a formfitting manner or extend through it. The mentioned form fit advantageously enables a still further increase of the structural attachment, in addition to the mentioned enlargement of the attachment surface.

In one embodiment, the solid material elements extend in the transition area over a length of at least 0.1 mm to 0.5 mm, 1 mm, or 10 mm, preferably 0.2 mm, or overlap accordingly with the porous structure.

In one embodiment, the component structure is part of a component which is furthermore a component to be cooled of the hot gas path of a turbomachine, such as a stationary gas turbine, a turbine blade, a heat shield component of a combustion chamber, a resonator component, and/or an acoustic damper, or an acoustic damping combustion component.

A further aspect of the present invention relates to a method for additive manufacturing of the last-mentioned component structure by means of selective laser melting or electron-beam melting, wherein initially the porous structure is constructed and areas for the solid material elements are subsequently constructed. For example, for this purpose the porous structure in the porous component area can be irradiated again using different irradiation parameters, which enable a solid material solidification.

The mechanical attachment can thus furthermore be significantly improved.

Embodiments, features, and/or advantages which relate in the present case to the method for providing manufacturing instructions or the manufacturing methods can furthermore relate directly to the additively manufactured component structure, and vice versa.

The expression “and/or” used here, when it is used in a series of two or more elements, means that each of the listed elements can be used alone, or any combination of two or more of the listed elements can be used.

Further details of the invention are described hereinafter on the basis of the figures.

### BRIEF DESCRIPTION OF THE DRAWINGS

FIG. 1 shows a schematic sectional view of a powder bed-based, additive manufacturing process.

FIG. 2 indicates, according to the present invention, an additively manufactured structure having a continuous porosity gradient.

FIG. 3 shows a schematic top view of a hatching irradiation pattern, according to which a structure can be additively manufactured according to the invention.

FIG. 4 indicates, according to the present invention, an additively manufactured structure having a stepped porosity gradient.

FIG. 5 indicates an additively manufactured structure having a porous area and solid material elements according to an alternative embodiment of the present invention.

### DETAILED DESCRIPTION OF INVENTION

In the exemplary embodiments and figures, identical or identically acting elements can each be provided with identical reference signs. The elements shown and their size relationships to one another are fundamentally not to be viewed as to scale, rather individual elements can be shown dimensioned exaggeratedly thick or large for better illustration capability and/or for better understanding.

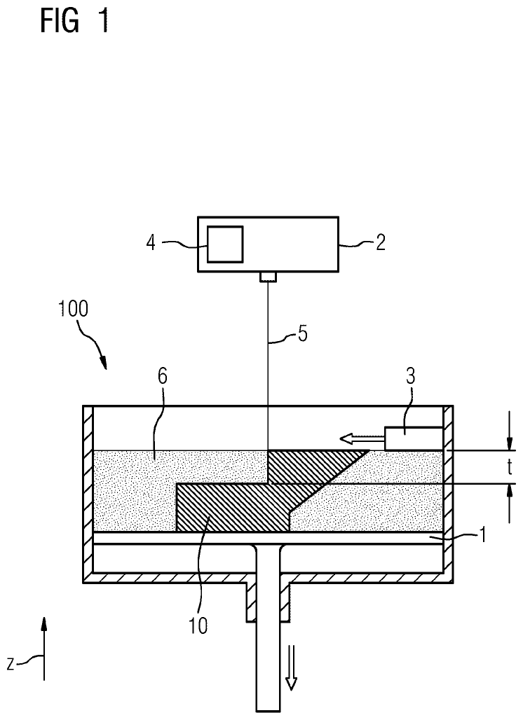

FIG. 1 shows an additive manufacturing facility 100. The manufacturing facility 100 is preferably designed as an LPBF facility and for the additive construction of components from a powder bed. The facility 100 can also relate to a facility for electron-beam melting. Accordingly, the facility includes a construction platform 101. A component 20 to be additively manufactured is manufactured in layers from a powder bed on the construction platform 101. The powder bed is formed by a powder 6, which can be distributed in layers on the construction platform 1 by a coating device 3. After the application of each powder layer (cf. layer thickness t), according to the specified geometry of the component 20, areas of the layer are selectively melted using an energy beam, for example a laser or electron beam, by an irradiation device 2 and subsequently solidified.

After each layer, the component platform 1 is preferably lowered by an amount corresponding to the layer thickness t (cf. arrow directed downward in FIG. 1). The thickness t is typically only between 20 and 40 μm, so that the entire process can easily require the irradiation of thousands to tens of thousands of layers.

In this case, high temperature gradients, for example, of 10⁶ K/s or more, can occur due to the energy introduction, which only acts very locally. A tension state of the component is obviously accordingly large during the construction and also after, which significantly complicates the additive manufacturing processes in general.

The geometry of the component is typically defined by a CAD file (“computer aided design”). After such a file is read into the manufacturing facility 100 or a corresponding control unit, the process then initially requires defining a suitable irradiation strategy, for example, by means of CAM (“computer aided manufacturing”), due to which the component geometry is also typically divided into the individual layers (“slicing”).

The component 10 is preferably a coolable component, to be cooled in operation, of the hot gas path of a turbomachine, such as a turbine blade, a heat shield component of a combustion chamber, and/or a resonator or damper component, such as a Helmholtz resonator. Alternatively, the component 10 can be a ring segment, a burner part or a burner tip, a frame, a shield, a heat shield, a nozzle, a seal, a filter, an orifice or lance, a plunger, or an agitator, or a corresponding retrofit part.

The present invention relates to a method for providing CAM manufacturing instructions (CAM method) for the additive manufacturing of a component 10, as was described on the basis of FIG. 1.

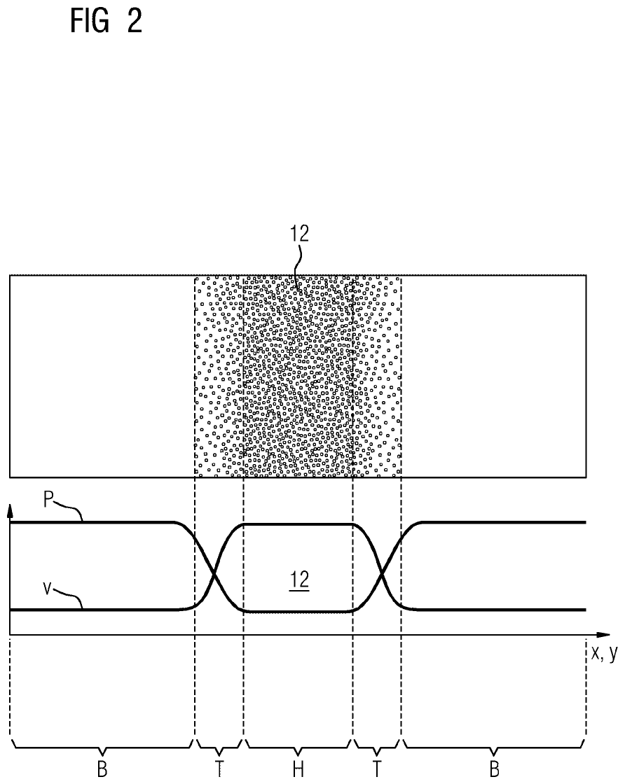

The geometry of the component 10 is partially shown in FIG. 2 and is typically defined on the basis of CAD data. The geometry of the component, to the manufacturing of which the mentioned manufacturing instructions are directed, comprises a solid material area B, a transition area T, and a porous component area T (cf. FIGS. 2 to 5 below).

In the context of the mentioned CAM method, irradiation parameters for the manufacturing of the component, at least comprising an irradiation power P, a scanning speed v, a scanning distance d, and a layer thickness t, are now furthermore varied within the transition area T in such a way that a porosity gradient of the structure of the component 10 is formed between the solid material area B of the component 10 and the porous component area H. The porous component area H is preferably provided as a cooling area or cooling structure and is accordingly configured to have a cooling fluid flow through it for cooling in operation of the component.

In particular, FIG. 2 shows a correspondingly graduated component structure or a graduated porosity of the component in the upper part. In the lower part of the illustration, in accordance with the position from left to right, an irradiation power P, for example laser power, and a scanning speed v are plotted qualitatively (can be specified in percent of a normal or standard value) over a spatial direction x, y (cf. lateral extension of the powder bed) and/or the construction direction z (latter not explicitly identified in the figures).

It can be seen that the laser power is selected relatively high in the left area of the component for solidifying a solid material structure. In the transition area T adjoining to the right on the solid material area B, the irradiation power P drops to a significantly weaker amount, in order to then assume a constant low value in the porous material area H following on the right. A reduced laser power—for example in comparison to standard parameters—advantageously allows the reduction of the material density and thus the control of a (tailored) porosity 12 in the porous area H of the component 10.

Of course, it is known to a person skilled in the art that the selection of specific parameter values and their influence on the porosity of the component to be manufactured accordingly are furthermore dependent on the type of the powdered material.

In the middle of the porous area H, the irradiation power P and the scanning speed v extend mirror symmetrically, since a transition area T and a corresponding component area B in turn adjoin the porous area H (see farther to the right in FIG. 2).

Precisely counter to the effect of the irradiation power, a reduced scanning speed v—for example in comparison to standard parameters—also causes an increased porosity due to a spatially or temporally reduced energy introduction, which accordingly no longer contributes to the solidification of the powdered starting material. Starting from a comparatively low scanning speed in the component area B shown on the left, it is therefore increased in the left transition area T up to a (constant) maximum value in the porous component area H.

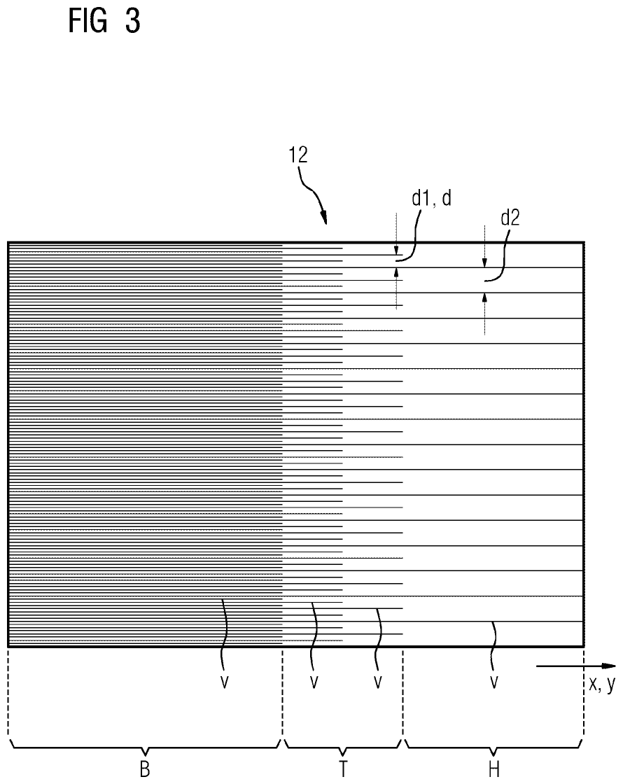

In the course of the described selective laser melting, laser sintering, or electron beam melting process, the component is thus advantageously provided according to the invention with a porosity gradient in the transition area T.

Where this is not explicitly identified, further parameters can alternatively or additionally be varied in order to generate a finished, preferably gradually varying porosity in the transition areas. In particular, a scanning distance can furthermore be varied (cf. FIG. 3 farther below). Moreover, for example, the layer thickness T can be varied; however, this is only practically usable in multiples of the “solid material layer thickness” t and along the construction direction z.

FIG. 3 shows a schematic top view of a hatching irradiation pattern, in which, also in a step preparing for the construction process, a scanning distance d of irradiation vectors (from left to right in the image) is varied in such a way that a density or porosity gradient is set from the solid material area B via the transition area T to the porous area H. This is possible along or with respect to each lateral direction (x/y direction) of the powder bed. In particular to manufacture a greater porosity, the scanning distance d, d1, d2 is increased in multiple steps or in a stepped manner. This takes place immediately with uniform melting track width (constant remaining irradiation parameters). In the right part of the illustration, a scanning distance d2 is shown by way of example which corresponds to double the amount of the scanning distance d1 (see area T).

According to the invention, one or more of the mentioned irradiation parameters P, v, d, t can be selected in such a way that the structure 12 of the component 10 in the porous component area H is between 5% and 40%, preferably approximately 20%.

Furthermore, one or more of the irradiation parameters can be selected in such a way that the structure 12 of the component 10 in the transition area T has a gradually varying porosity between approximately 0 in the solid material area B to a porosity value of the porous component area H of preferably approximately 20%.

Furthermore, one or more of the irradiation parameters can be selected in such a way that the porosity is formed continuously or infinitely (fluidly) varying. This is to be illustrated by the situation as shown in FIG. 2.

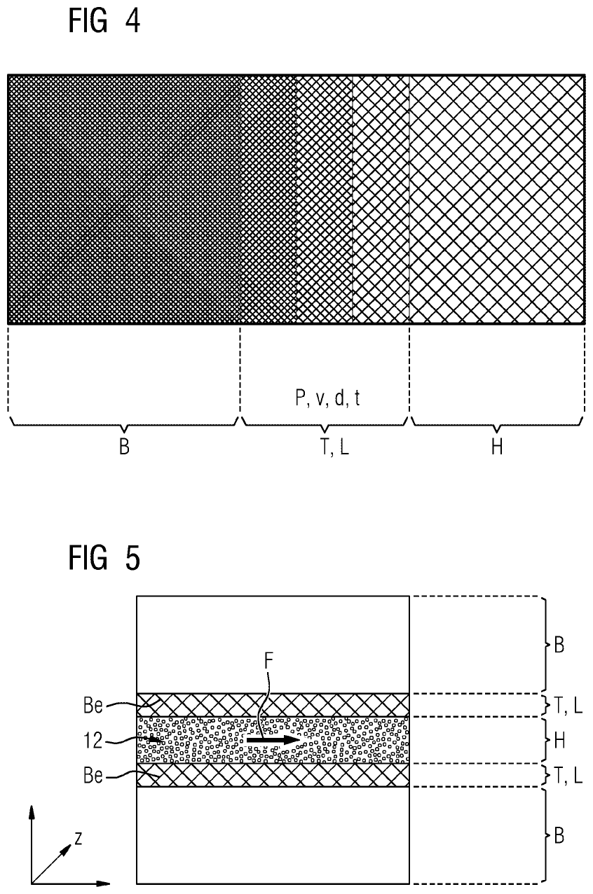

Furthermore, one or more of the irradiation parameters can be selected in such a way that the porosity is formed in a stepped manner (gradually). This embodiment corresponds to the situation from FIG. 4.

FIG. 4 indicates in particular from left or right on the basis of the differently hatched areas a stepped porosity or density profile of the correspondingly manufactured structure for the component 10. Gradual gradations between the solid material area B and the porous area H are shown within the area T.

FIG. 5 shows an additively manufactured component structure 10 according to an alternative embodiment of the present invention. The structure for the component can also be a component wall, for example.

The differently oriented arrows on the bottom left in the illustration of FIG. 5 are to indicate that the component can be constructed in the present case according to arbitrary construction directions and the vertical alignment shown of the component does not necessarily have to correspond to the construction direction specified by the process.

The middle area again represents the porous component area H. The arrow in the middle indicates a possible through-flow direction for a cooling fluid F, according to which the component area shown could be cooled in operation of the component (not shown in the previous figures solely for the sake of simplicity). In the present case (for example), a symmetry line, with respect to which the area shown is symmetrically formed, extends longitudinally in the middle of the porous area (approximately at the height of the arrow F).

Solely by way of example, the component area is furthermore provided with two symmetrical and identical transition areas T. According to the invention, in the transition areas T according to this embodiment, volume or solid material elements Be are provided, which preferably extend like gratings or struts from the solid material areas shown into areas of the porous structure, or permeate them. The solid material elements Be preferably permeate the porous structure 12 at least partially in a formfitting manner.

In contrast to the above-described embodiment of the component structure that is to be additively manufactured, a reinforced mechanical attachment of the porous structure to the solid material areas Be is not directly implemented here by a graduation of porous material (gradual parameter variation), but rather—as described—by the solid material elements Be extending into the porous structure.

The solid material elements Be can extend, for example, in the transition area over a length L of 0.1 mm to 0.5 mm, or more, for example, 1 mm, 2 mm, 3 mm, 4 mm, 5 mm, or 10 mm, preferably 0.2 mm, into the porous structure to effectuate the strongest possible mechanical anchoring.

According to the present invention, during the powder bed-based additive manufacturing process (cf. FIG. 1 above) by means of selective laser melting or electron beam melting, preferably initially the porous structure 12 is constructed and areas of the solid material elements Be are subsequently constructed. As indicated above, this can be carried out in layers (layer sequence not explicitly identified here) according to any arbitrary construction direction Z.

A graduation of the porosity in the transition areas along a rotation angle, pivoted, can also take place, without this being explicitly identified in the figures.

According to the second alternative according to the invention to the additive component structure, the solid material elements Be can also extend different distances, for example only minimally radially inward, but instead significantly farther radially outward, into the porous structure.

1. A method for additive manufacturing of a component by selective laser melting or electron beam melting using manufacturing instructions (CAM) provided for the additive, powder bed-based manufacturing of a component, comprising:
defining a geometry of the component, comprising a solid material area, a transition area, and a porous component area on the basis of CAD data,
varying irradiation parameters for the manufacturing of the component, comprising an irradiation power, a scanning speed, a scanning distance, and a layer thickness within the transition area in such a way that a porosity gradient of the structure of the component is formed between the solid material area WO of the component and the porous component area, and
reducing an irradiation power in the transition area from the solid material area to the porous component area.

2. The method as claimed in claim 1,
wherein at least one irradiation parameter is selected in such a way that the structure of the component in the porous component area is between 5% and 40%.

3. The method as claimed in claim 1,
wherein at least one irradiation parameter is selected in such a way that the structure of the component in the transition area has a gradually varying porosity between approximately 0 in the solid material area to a porosity value of the porous component area of approximately 20%.

4. The method as claimed in claim 3,
wherein at least one irradiation parameter is selected in such a way that the porosity is formed continuously or infinitely gradually varying.

5. The method as claimed in claim 3,
wherein at least one irradiation parameter is selected in such a way that the porosity is formed gradually varying in a stepped manner.

6. The method as claimed in claim 1,
wherein a scanning speed is increased in the transition area from the solid material area to the porous component area.

7. The method as claimed in claim 1,
wherein a scanning distance in the transition area is increased from the solid material area to the porous component area.

8. A computer program product stored on a non-transitory computer readable medium, comprising:
commands which, upon execution of a corresponding program by a computer, to control irradiation in an additive manufacturing facility, cause it to implement the method as claimed in claim 1 or to manufacture the component accordingly.

9. An additively manufactured component structure, comprising:
a solid material area, a transition area, and a porous component area, wherein the porous component area is a cooling body, which is configured to have a cooling fluid flow through it to cool the structure in operation, and wherein the transition area includes a porous structure, through which grating-like solid material elements extend.

10. The additively manufactured component structure as claimed in claim 9,
wherein the solid material elements permeate the porous structure at least partially in a formfitting manner.

11. The additively manufactured component structure as claimed in claim 9,
wherein the solid material elements extend in the transition area over a length of 0.1 mm to 0.5 mm.

12. A component, comprising:
a component structure as claimed in claim 9, wherein the component is a component to be cooled of a hot gas path of a turbomachine, such as a turbine blade, a heat shield component of a combustion chamber, a resonator component, and/or an acoustic damper.

13. A method for additive manufacturing of the component structure as claimed in claim 9 by selective laser melting or electron beam melting, comprising:
constructing initially the porous structure, and
subsequently constructing areas of the solid material elements.

14. The method as claimed in claim 2,
wherein at least one irradiation parameter is selected in such a way that the structure of the component in the porous component area is approximately 20%.

15. The additively manufactured component structure as claimed in claim 11,
wherein the solid material elements extend in the transition area over a length of 0.2 mm.
